(19) United States
(12) Patent Application Publication
(10) Pub. No.: US 2009/0139208 A1
(43) Pub. Date: Jun. 4, 2009

(54) METHOD FOR PREPARING A POROUS STRUCTURE USING SILICA-BASED PORE-FORMING AGENTS

(75) Inventors: Daniel Urffer, Saint-Saturnin (FR); Carine Barataud-Dien, Lambesc (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN CTR DE RECH. ET

(21) Appl. No.: 11/996,975

(22) PCT Filed: Jul. 19, 2006
(86) PCT No.: PCT/FR06/50731

§ 371 Date: Jul. 30, 2008

(30) Foreign Application Priority Data
Jul. 29, 2005 (FR) 0552393

(51) Int. Cl. F01N 3/022; C04B 35/565; B32B 3/12

(52) U.S. Cl. 60/274; 264/630; 428/116; 501/88

(57) ABSTRACT

The invention relates to a process for manufacturing a porous silicon carbide structure of the honeycomb type, said process being characterized in that it comprises the following steps: forming of a paste from a mixture of silicon carbide grains, the diameter d₅₀ of which is between 5 μm and 300 μm, of an organic binder and of an inorganic pore former, in the form of particles based on silica, the overall porosity of said particles being greater than 70%; forming of a honeycomb-shaped green plastic monolith; drying of said monolith; and firing of the monolith at a temperature greater than 2100° C.

The structure obtained by the process may be used as catalytic support in an exhaust line of a diesel or petrol engine or as particulate filter in an exhaust line of a diesel engine.

The invention relates to the field of filter structures, especially those used in an exhaust line of an internal combustion engine of the diesel or petrol type.

Filters used for eliminating the soot coming from a diesel engine are well known in the prior art. These structures usually have a honeycomb structure, one of the faces of the structure allowing the entry of the exhaust gases to be treated and the other face the exit of the treated exhaust gases. The structure comprises, between the entry and exit faces, a number of adjacent ducts or channels of mutually parallel axes separated from one another by porous walls. The ducts are closed off at one or other of their ends so as to define entry chambers that open out on the entry face and exit chambers opening out on the exit face. The channels are closed off alternately in an order such that the exhaust gases, during passage through the honeycomb body, are forced to pass through the lateral walls of the entry channels so as to rejoin the exit channels. In this way, the soot particles are deposited and accumulate on the porous walls of the filter body.

As is known, during its use the particulate filter is subjected to a succession of filtration (soot accumulation) and regeneration (soot elimination) phases. During filtration phases, the soot particles output by the engine are retained and deposited inside the filter. During regeneration phases, the soot particles are burnt off inside the filter, so as to restore the filtration properties of the filter.

The materials employed in such structures must therefore be characterized not only by having suitable pore dimensions (porosity, median pore size), so as to allow the gases to pass through the walls, but also by having a high thermomechanical resistance. It is known that filters based on silicon carbide allow such properties to be obtained.

Examples of such filters are for example described in patent applications EP 816 065, EP 1 142 619, EP 1 455 923, or else WO 2004/090294 and WO 2004/065088.

The production of porous structures based on silicon carbide usually comprises firstly the formation of a loose paste followed thereafter by the forming, by extrusion, of a honeycomb-shaped plastic monolith. The green monolith obtained is then placed in a furnace where it is fired at high temperature, for example at a temperature above 2100° C.

It is known that it is indispensable for a temporary binder to be incorporated into the initial paste. Present at the start of firing, this binder makes it possible in particular for the silicon carbide grains to be joined together and promotes the formation of pores during solidification of the structure.

As is known, to obtain levels of porosity of the walls of the structure compatible with use as a particulate filter, that is to say porosities of between 20 and 65%, it is in general essential also to introduce organic pore formers into the mixture. These organic pore formers are vaporized at relatively high temperature during the firing. Pore formers such as polyethylene, polystyrene, starch or graphite are described in applications JP 08-281036 and EP 1 541 538.

It is known, for example from application EP 1 541 538, that there are difficulties arising in the step of eliminating the organic compounds in the first stages of the firing. This first firing phase, commonly called binder removal in the art, relates in general mainly to the elimination of the binder and pore former from the structure at a temperature between 100 and 750° C. During binder removal, the uncontrolled combined combustion of the binders and of the organic pore formers present in the structure may result in large thermal gradients within the structure. Binder removal is consequently a critical step in the process of firing the filter structures, which step may be the cause of major defects in the final structure. To prevent the appearance of cracks during the step of removing the binder from a porous ceramic material, patent application EP 1 541 538 proposes to impose a temperature hold, in air, of between 50° C. below and 10° C. above the temperature at which combustion of the temporary binder starts. According to the authors, by using such a method the thermal gradient within the filter, brought about by the combined combustion of the binder and the pore former and leading to cracking, is effectively reduced. However, this method requires the duration of the binder removal cycle to be considerably extended and consequently reduces the productivity of the process in its entirety. Moreover, this process proves to be not easy to control for products having various combinations of temporary binders or also including other organic agents, such as for example plasticizers, wetting agents or lubricants.

One object of the present invention is firstly to propose an alternative solution, making it possible to avoid the problems associated with the appearance of high thermal stresses during the binder removal step and eventually of defects in the filter.

In a very general form, the invention relates to a facilitated process for obtaining a honeycomb structure having a porosity suitable for use as a filter, especially for filtering the soot output by a diesel engine. According to the process, silica-based inorganic porous particles are used as pore former.

The use of hollow inorganic particles is for example described in patent application JP 2001-206785 in order to obtain filters made of silicon carbide having a high porosity and good mechanical strength. The pore formers used are based on alumina and silica. The process described differs from the present process by the size of the silicon carbide grains employed, the firing temperature used, and the chemical composition of the hollow particles. These balls, of the E-sphere or Microcell type, contain in fact a very high proportion of alumina. Furthermore, the process must be implemented with a maximum SiC grain size of 3 μm. According to the authors, a larger grain size does not allow sintering to be obtained nor a sufficient mechanical strength of the filter.

More precisely, the present invention relates to a process for manufacturing a porous silicon carbide structure of the honeycomb type, said process being characterized in that it comprises the following steps:
a) forming, in the presence of water, of a paste from a mixture of silicon carbide SiC grains, the median diameter d₅₀ of which is between 5 μm and 300 μm, preferably between 10 and 150 μm, of an organic binder and of an inorganic pore former, in the form of particles based on silica, the alumina weight content of which is less than 15%, the overall porosity of said particles being greater than 70%;
b) forming, preferably by extrusion, of a honeycomb-shaped green plastic monolith;
c) drying of the monolith; and
d) firing of the monolith at a temperature greater than 2100° C.

Within the context of the present description, the median diameter d₅₀ denotes here the diameter of the particles above which 50% by weight of the particle population lies.

According to one advantageous embodiment of the invention, at least 10% by weight of said SiC grains have a diameter greater than 5 μm, the median diameter d₅₀ of this particle size fraction being between 5 μm and 300 μm, preferably between 10 and 150 μm.

For example, a mixture according to the invention may be obtained from at least two grain fractions, one grain fraction having grains with a size of between 0.1 and 10 μm, preferably between 0.1 and 5 μm, and a grain fraction having grains with a size of between 5 μm and 300 μm, preferably between 10 and 150 μm.

The term “silica-based particle” is understood to mean, within the context of the present description, that silica represents at least 50%, preferably at least 60% and very preferably at least 65% of the total mass of the oxides constituting the particle.

Advantageously, the particles are approximately spherical hollow or solid balls having a mean diameter between 5 and 100 μm, preferably between 10 and 30 μm.

For example, when the balls are hollow, the thickness of the wall is less than 30% of the mean diameter of the particles, preferably less than 10% of said diameter or even less than 5%.

Without departing from the scope of the invention, the silicon-based particles may contain alumina Al₂O₃ with a weight content of less than 10%, or even less than 5% or indeed less than 1%. Very preferably, the alumina is present according to the invention only in the form of unavoidable impurities.

For example, the silica-based particles comprise the following elements, in percentages by weight:
SiO₂: from 50 to 99% and preferably greater than 65%;
Na₂O: from 0 to 20% and preferably from 1 to 15%;
CaO: from 0 to 15% and preferably from 1 to 10%;
B₂O₃: from 0 to 20% and preferably from 1 to 6.5%;
P₂O₅: from 0 to 5% and preferably from 0.5 to 1.5%, the balance consisting of unavoidable impurities.

The firing step may be carried out in air at a temperature between 300 and 750° C., then in a nonoxidizing, preferably inert, atmosphere at a temperature between 2100 and 2450° C.

The heating rate during the firing step in air is between for example 5 and 200° C./h according to the present process, preferably between 10 and 150° C. per hour, advantageously with no intermediate temperature hold.

The amount of pore-forming particles by weight, relative to a base 100 by weight of SiC, is usually between 1 and 30, preferably between 1 and 17.

The invention also relates to a porous silicon carbide structure of the honeycomb type that can be obtained by the process described above.

In particular, the porous structure obtained by the present process may be used as catalytic support in an exhaust line of a diesel or petrol engine or as particulate filter in an exhaust line of a diesel engine.

The invention will be more clearly understood on reading the following examples, which are given by way of illustration but do not limit the invention in any of the aspects described. In these examples, all the percentages are given by weight.

### EXAMPLES

In the examples, two silicon carbide grain fractions were used. A first fraction had a median diameter d₅₀ between 5 μm and 50 μm and at least 10% by weight of the grains making up this fraction had a diameter greater than 5 μm. The second fraction had a median grain diameter of less than 5 μm. The two fractions were mixed in a 1/1 weight ratio with a temporary binder of the methylcellulose type and with a pore former. Table 1 indicates the respective proportions by weight of these various constituents in the mixture, relative to 100 reference by weight of SiC.

The pore former was either a polyethylene organic pore former representative of the prior art (Examples 1, 3 and 5) or an inorganic pore former according to the invention (Examples 2, 4 and 6). The silica-based pore former used, sold by Potters under the reference Sphericel 110P8®, was in the form of hollow beads with a mean diameter of about 10 μm and comprising 70% SiO₂ by weight, 13% Na₂O by weight, 7% CaO by weight and 5% B₂O₃ by weight. The wall thickness of the hollow beads was between 1 and 5% of the mean diameter of the particles.

To be directly comparable, the trials were carried out with constant volume of pore former between Examples 1 and 2, 3 and 4 or 5 and 6, respectively. The difference in density between the organic and inorganic pore formers used explains why the proportions by weight of pore formers in mixtures 1 and 2, 3 and 4 or 5 and 6 respectively are slightly different.

TABLE 1

| Example | 1 | 2 | 3 | 4 | 5 | 6 |
|---|---|---|---|---|---|---|
| SiC granular mixture | 100 | 100 | 100 | 100 | 100 | 100 |
| (>98 wt %) | | | | | | |
| Organic pore former | +3 | | +7.5 | | +12 | |
| (polyethylene) | | | | | | |
| (20-100 μm diameter) | | | | | | |
| Inorganic pore former | | +3.5 | | +8.5 | | +14 |
| (Sphericel 110P8) | | | | | | |
| SiC/pore former mass | 33.3 | 28.6 | 13.3 | 11.8 | 8.3 | 7.1 |
| ratio | | | | | | |
| Temporary binder: | +8 | +8 | +8 | +8 | +8 | +8 |
| methylcellulose | | | | | | |
| Water | +20 | +20 | +20 | +20 | +20 | +20 |

The mixtures were mixed for 10 minutes in the presence of water in a mixer until a homogeneous paste was obtained. The paste was stretched for 30 minutes so as to make the paste plastic and to remove the air from the mixture.

The honeycomb monoliths were then extruded with a pressure of around 60 kg/cm². The thickness of the internal walls of the extruded structure was about 0.3 mm.

The monoliths were then cut to a length of 6″ (1 inch=2.54 cm) and then dried by microwaves until a residual moisture of less than 1% water by weight was reached.

The structures were then subjected to a first binder removal step in air, mainly allowing elimination of the binder at a maximum temperature of 750° C. and at a heating rate of 30° C./h with no intermediate temperature hold. This first heating step was immediately followed by a firing step in argon at a temperature of at least 2100° C., but below 2450° C.

The monoliths were then fired at this temperature for two hours and then slowly cooled down to room temperature.

The DTA/DSC analyses, using a Netszch® machine with a heating rate of 5° C./minute, on specimens of Examples 1, 3 and 5 showed a very pronounced exotherm at about 210° C. and at around 300° C. The DTA/DSC analyses on the specimens corresponding to Examples 2, 4 and 6 showed no exotherm peaks during binder removal in air at temperatures up to 750° C.

Using well-known techniques, the porosity and the median pore diameter were measured by mercury (Hg) porosimetry. The modulus of rupture was measured on extruded bars measuring 6×8×60 mm in 3-point bending according to the ISO 5014 standard.

The structures finally obtained were analyzed and visually inspected in order to detect the presence of external or internal defects, such as for example cracks.

The results of the tests are given in Table 2.

TABLE 2

| Example | 1 | 2 | 3 | 4 | 5 | 6 |
|---|---|---|---|---|---|---|
| Maximum monolith | 2100 | 2100 | 2100 | 2100 | 2100 | 2100 |
| firing temperature | | | | | | |
| (° C.) | | | | | | |
| % porosity (Hg) | 44 | 45 | 48 | 48 | 52 | 52 |
| Median pore diameter | 13 | 15 | 15 | 18 | 19 | 21 |
| (μm) | | | | | | |
| Modulus of rupture MOR | 37 | 38 | 27 | 29 | 18 | 22 |
| (MPa) | | | | | | |
| Presence of defects | Yes | No | Yes | No | Yes | No |
| (internal cracks) | | | | | | |

All the structures prepared under the conditions of the prior art (Examples 1, 3 and 5) had cracks, whereas all the structures obtained according to the invention had no defects, although prepared under the same conditions. In addition, for substantially equivalent porosity and pore diameter, it may be noted that the filter obtained with the inorganic pore former according to the invention has a slightly improved mechanical strength.

In the description and the examples above, for the sake of simplicity, the invention was described in relation to optionally catalyzed particulate filters for eliminating soot or gaseous pollutants present in the exhaust gas output by an exhaust line of a diesel engine. The present invention is however applicable also to catalytic supports for the elimination of gaseous pollutants output by petrol or diesel engines. In this type of structure, the channels of the honeycomb are not obstructed at one or other of their ends.

1. A process for manufacturing a porous silicon carbide structure of the honeycomb type, said process comprises the following steps:
a) forming, in the presence of water, of a paste from a mixture of silicon carbide grains, the diameter d₅₀ of which is between 5 μm and 300 μm, of an organic binder and of an inorganic pore former, in the form of particles based on silica, the alumina weight content of which is less than 15%, the overall porosity of said particles being greater than 70%;
b) forming, a honeycomb-shaped green plastic monolith;
c) drying of said monolith; and
d) firing of the monolith at a temperature greater than 2100° C.

2. The process as claimed in claim 1, wherein at least 10% by weight of said SiC grains have a diameter greater than 5 μm, the median diameter d₅₀ of this particle size fraction being between 5 μm and 300 μm.

3. The process as claimed in claim 1, wherein the mixture is obtained from at least two grain fractions, including:
a grain fraction in which the median diameter of the grains is between 0.1 and 10 μm; and
a grain fraction in which the median diameter of the grains is between 5 μm and 300 μm.

4. The process as claimed in claim 1, wherein said particles are approximately spherical hollow or solid balls having a mean diameter between 5 and 100 μm.

5. The process as claimed in claim 4, wherein the balls are hollow, the thickness of the wall being less than 30% of the mean diameter of the particles.

6. The process as claimed in claim 1, wherein the silica-based particles have an alumina weight content in the silica-based particles of less than 10%.

7. The process as claimed in claim 1, the silica-based particles comprise the following elements, in percentages by weight:
SiO₂: from 50 to 99%;
Na₂O: from 0 to 20%;
CaO: from 0 to 15%;
B₂O₃: from 0 to 20%;
P₂O₅: from 0 to 5%,
the balance consisting of unavoidable impurities.

8. The process as claimed in claim 1, in which the firing step is carried out in air at a temperature between 300 and 750° C., then in a nonoxidizing inert, atmosphere at a temperature between 2100 and 2450° C.

9. The process as claimed in claim 8, in which the heating rate during the firing step in air is between 5 and 200° C./h, with no intermediate temperature hold.

10. The process as claimed in claim 1, wherein the amount of pore-forming particles by weight, relative to a base 100 by weight of SiC, is between 1 and 30.

11. A porous silicon carbide structure of the honeycomb type that can be obtained by a process as claimed in claim 1.

12. The method of using a structure obtained by the process as claimed in claim 1 as catalytic support in an exhaust line of a diesel or petrol engine or as particulate filter in an exhaust line of a diesel engine.

13. The process of claim 1 wherein the silicon carbide grains have a diameter between 10 and 150 μm.

14. The process of claim 1 wherein a honeycomb-shaped green plastic monolith is formed by extension.

15. The process of claim 3 wherein the median diameter of the grain is between 0.1 and 5 μm.

16. The process of claim 4 wherein the particles are spherical or solid balls having a mean diameter between 10 and 30 μm.

17. The process of claim 5 wherein the mean diameter of the particle is less than 10% of said diameter or even less than 5%.

18. The process of claim 6 wherein the aluminum contrast is less than 5%.

19. The process of claim 7 wherein the percentage weight of
SiO₂ is greater than 65%
Na₂O is from 1 to 15%
CaO is from 1 to 10%
B₂O₃ is from 1 to 6.5% and
P₂O₅ is from 0.5 to 1.5%.

20. The process of claim 9 wherein the air is between 10 and 150° C. per hour during the filtering step.
